(19) United States
(12) Patent Application Publication
(10) Pub. No.: US 2016/0306058 A1
(43) Pub. Date: Oct. 20, 2016

(54) REVERSE TIME MIGRATION BASED ON GEOMETRIC MEAN FOR IMAGING SEISMIC SOURCES

(71) Applicant: The Board of Trustees of the Leland Stanford Junior Univerisity, Stanford, CA (US)

(72) Inventors: Norimitsu Nakata, Stanford, CA (US); Gregory C. Beroza, Stanford, CA (US)

(21) Appl. No.: 15/130,705

(22) Filed: Apr. 15, 2016

Related U.S. Application Data
(60) Provisional application No. 62/148,543, filed on Apr. 16, 2015.

(51) Int. Cl. G01V 1/28

(52) U.S. Cl. CPC G01V 1/282; G01V 2210/679; G01V 2210/123

(57) ABSTRACT

For each receiver of an array of three or more receivers monitoring a seismic event, reverse time propagation of a recorded wavefield is performed for the respective receiver to derive an extrapolated wavefield for the respective receiver. An imaging condition is applied as a crosscorrelation of the extrapolated wavefields for the three or more receivers to derive an image of the seismic event. A source of the seismic event is identified based on the image.

### CROSS-REFERENCE TO RELATED APPLICATION

This application claims the benefit of U.S. Provisional Application No. 62/148,543, filed on Apr. 16, 2015, the disclosure of which is incorporated herein by reference in its entirety.

### TECHNICAL FIELD

This disclosure generally relates to a technique to detect, locate, and characterize seismic events from seismic records.

### BACKGROUND

Seismic events can range from large-scale earthquakes to microseismic events, such as caused when fluid injection during fracturing and production lead to deformation, fluid movement, and a change in geomechanical condition of hydrocarbon and geothermal reservoirs. Seismic source locations are typically determined using a combination of arrival times and ray-based velocity models. Relative source locations can be obtained through the use of arrival time differences between pairs of events. Although effective for large-scale seismic events, identification of arrival times can present a challenge for small-scale seismic events.

Improvements in computational power allow the use of waveforms, rather than just arrival times, for source location estimation. Based on a wave equation with a given velocity model, time-reversed extrapolation of observed wavefields can be computed. The extrapolated wavefields focus at a location of a seismic source with a reasonably accurate velocity model. The extrapolated wavefields have four dimensions (time and space), and, therefore, scanning in four dimensions is performed to identify a location of a seismic source, which renders the technique computationally demanding.

It is against this background that a need arose to develop the embodiments described in this disclosure.

### SUMMARY

Time reversal is a powerful technique that can be used to image directly a location and mechanism of passive seismic sources. This technique assumes seismic velocities in a medium and propagates time-reversed observations of ground motion at each receiver location. Assuming a reasonably accurate velocity model and adequate array aperture, extrapolated wave fields can focus at a source location. Because the location and an origin time may not be known a priori, scanning in four dimensions (three dimensions in space and one dimension in time) would otherwise be performed to localize the source, which renders time-reversal imaging computationally demanding.

Some embodiments of this disclosure are directed to an improved technique of time-reversal imaging that reduces a computational cost and scanning dimensions from four dimensions to three dimensions (no time) and increases a spatial resolution of a source image. In some embodiments, wavefields at each receiver are individually extrapolated, and then these extrapolated wavefields are crosscorrelated at each location (a product in the frequency domain: geometric mean). This crosscorrelation yields an image, and focusing of the seismic wavefields occurs at a zero time lag of the correlation with a sufficiently accurate velocity model. This improved technique can be referred to as geometric-mean reverse time migration or GmRTM. In addition to reducing the dimensions from four to three, the crosscorrelation effectively suppresses side lobes and yields a spatially high-resolution image of seismic sources. GmRTM is robust for random and coherent noise because the crosscorrelation enhances signal and suppresses noise. A further added benefit is that GmRTM can be used to retrieve and update velocity information by analyzing either, or both, time and space lags of crosscorrelation.

Other aspects and embodiments of this disclosure are also contemplated. The foregoing summary and the following detailed description are not meant to restrict this disclosure to any particular embodiment but are merely meant to describe some embodiments of this disclosure.

### BRIEF DESCRIPTION OF THE DRAWINGS

For a better understanding of the nature and objects of some embodiments of this disclosure, reference should be made to the following detailed description taken in conjunction with the accompanying drawings.

FIG. 1. Schematic diagrams of (a) observation, (b) virtual active shot, and (c) reverse time migration of the virtual active shot. The dark arrows show the direction of forward wave propagation, and the light arrows are extrapolated wave propagation for imaging.

FIG. 2. Flow chart of operations implemented according to GmRTM of some embodiments of this disclosure.

FIG. 3. Schematic of a system in which operations of GmRTM can be implemented according to some embodiments of this disclosure.

FIG. 4. (a) Acoustic velocity model (a part of the Marmousi model). The × and the dots indicate the locations of the source and receivers, respectively. The [symbol] at (2.6, 0.7) km shows another source location used in FIG. 8. (b) Recorded data. The background image shows wavefields at the surface, and the white lines illustrate the waveforms observed at each receiver.

FIG. 5. Time-reversal image (equation (2), I(x, t₀)) using the correct velocity for migration. The × and the dots show the locations of the source and receivers, respectively.

FIG. 6. Images around the source location obtained by (a) arithmetic-mean reverse time migration (AmRTM) (equation (2), I(x, t₀)), (b) autocorrelation RTM (equation (5)), and (c) geometric-mean RTM (GmRTM) (equation (6)). The amplitudes are independently normalized at each panel. The dashed lines show the depth and horizontal locations of the source. The dot indicates the location of the maximum amplitude for each image.

FIG. 7. Amplitudes of the images shown in FIG. 6 at (a) fixed depth and at (b) fixed distance of the source (the dashed lines in FIG. 6). The dashed lines in FIG. 7 indicate the location of the source.

FIG. 8. Images obtained from the data generated by the source at the [symbol] in FIG. 4. The dots show the location of the maximum amplitude of each image. The amplitudes are independently normalized at each panel. The right column shows the amplitudes of the images at fixed depth (top) and at a fixed distance (bottom) from the source.

FIG. 9. Images developed in the presence of velocity errors: using (a) smoothed velocity model, (b) 5% slow velocity, and (c) 10% slow velocity. The dots show the location of the maximum amplitude of each image. Amplitudes are normalized as in FIG. 6. The right column shows the amplitudes of the images at fixed depth (top) and at fixed distance (bottom) of the source.

FIG. 10. (a) Similar to FIG. 4b but for a source wavelet of 0.225 s duration. (b) Same as panel (a) but with band-limited random noise and coherent noise added.

FIG. 11. Images reconstructed from the data shown in FIG. 10. Panels (a and b) correspond to the data in FIGS. 10a and 10b, respectively. The right column shows the amplitudes of the images at fixed depth (top) and at fixed distance (bottom) of the source.

FIG. 12. (a) Image obtained for two simultaneously excited sources. The locations of two sources are illustrated by the intersections of the dashed lines in the images. The depth of the horizontal slice of the image is that of the shallower source. (b) Same as panel (a), but eight receivers are used instead of four. The right column shows the amplitudes of the images at fixed depth (top) and at fixed distance (bottom) of the shallower source.

FIG. 13. Source images obtained by AmRTM and GmRTM with different number of receivers. The model is an acoustic homogeneous model with velocity of 2 km/s, and the source is located at the center of the model (the intersection of dashed lines). The source function is the Ricker wavelet with 40 Hz peak frequency. The dots show the locations of receivers used for each image. For AmRTM, the correct source-excitation time is used for each image.

### DETAILED DESCRIPTION

Some embodiments of this disclosure are directed to an improved technique of time-reversal imaging in which a time axis is collapsed to reduce a computational cost while improving a spatial resolution of a source image. Because the technique is based on a multidimensional crosscorrelation or a product of wavefields, the technique can be referred to as geometric-mean reverse time migration (GmRTM).

Migration for Source Location Estimation

Forward wave propagation from a seismic source location xₛ to a receiver location xᵣ can be expressed as follows:

D(xᵣ, t)= [symbol] ⁻¹{S(xₛ, ω)G(xᵣ, xₛ, ω)}, (1)

where G and S are the Green's function and the source function, respectively; t and ω indicate time and frequency, respectively; I) is the recorded wavefield; and [symbol] ⁻¹ is the inverse Fourier transform.

For time-reversal imaging, recorded wavefields can be propagated in reverse time, and a four-dimensional (4D) image I can be obtained as follows:

$$I ( x , t ) = {ℱ}^{- 1} \{ {\sum }_{i} D ( {x}_{{r}_{i}} , ω ) {𝒢}^{*} ( {x}_{{r}_{i}} , x , ω ) \} , \qquad ( 2 )$$

where * is the complex conjugate, g is the approximated Green's function based on a given velocity model, and the summation over i is over all receivers. The term inside the curly bracket indicates a wavefield extrapolation of the observed data. The Green's function can be approximated using a finite-difference or other numerical solution of the wave equation. Observed records at all receivers can be back propagated simultaneously, and thus the summation in equation (2) can be computed implicitly. Because the entire observed wavefields D(x,ω) can be used, time-reversal imaging does not require arrival time identification. Therefore, time-reversal imaging is desirable for low signal-to-noise ratio (S/N) data such as microseismic records, in which arrival times of waves cannot be accurately identified in the data domain. However, identification of the time t₀ when I shows a maximum amplitude or a reasonably focused image for a seismic event would be performed in four dimensions.

If each receiver is treated independently, two receiver wavefields can be crosscorrelated to obtain another imaging condition as follows:

$$\begin{matrix}{ℐ}_{ij} ( x , 2 τ ) = {\sum }_{t} {W}_{{r}_{i}} ( x , t - τ ) {W}_{{r}_{j}} ( x , t + τ ) , \\ where & ( 3 ) \\ {W}_{{r}_{i}} ( x , t ) = {ℱ}^{- 1} \{ D ( {x}_{{r}_{i}} , ω ) {𝒢}^{*} ( {x}_{{r}_{i}} , x , ω ) \} . & ( 4 )\end{matrix}$$

Because wavefields D(xᵣᵢ) and D(xᵣⱼ) are generated by the same seismic source, wavefields Wᵣᵢ and Wᵣⱼ pass the source location at the same time; therefore, just τ=0 can be considered when g is sufficiently accurate. Images constructed by different receiver pairs provide the same source image with different artifacts, and hence an average of all receiver pairs should enhance the amplitude of the source image and suppress artifacts:

$$\begin{matrix}ℐ ( x ) = {\sum }_{i} {\sum }_{j} {ℐ}_{ij} ( x ) \\ = {\sum }_{t} \{ {\sum }_{i} {W}_{{r}_{i}} ( x , t ) \} \{ {\sum }_{j} {W}_{{r}_{j}} ( x , t ) \} \\ = {\sum }_{t} I ( x , t ) I ( x , t ) .\end{matrix} \qquad ( 5 )$$

Equation (5) corresponds to an autocorrelation of time-reversal images at zero time lag. Note that because of the autocorrelation, the time axis is collapsed in the image in equation (5); however, the use of autocorrelation as an imaging condition can smear an image when a number of receivers is insufficient.

For a zero time lag, [symbol] (x) (equation (3)) is a product of two receiver wavefields. Rather than summing over all wavefields (equation (5)), all receiver wavefields can be multiplied as an extension of equation (3) to obtain an imaging condition as follows:

$$𝒥 ( x ) = {\sum }_{i} {\prod }_{i} {W}_{{r}_{i}} ( x , t ) . \qquad ( 6 )$$

The use of equation (6) as an imaging condition can be referred to as GmRTM because of the role that the product of receiver wavefields plays in the imaging condition. This product can be interpreted as a multidimensional crosscorrelation and with the time axis collapsed. In GmRTM, wavefields can be extrapolated at each receiver (derive Wᵣᵢ(x,t)). Then, by considering just the zero time lag, all receiver wavefields can be multiplied at each space and time sample, and then summed over the time axis. Multiplication in the frequency domain can be derived as well. For the two receiver case, equation (6) corresponds to equation (3). Compared with equation (6), equation (2) (I(x,t)=Σᵢ Wᵣᵢ(x,t)) can be considered the arithmetic-mean RTM (AmRTM).

According to GmRTM, the wave equation can be solved independently for each receiver. To reduce the computational cost for wavefield extrapolation, it is contemplated that several receivers can be grouped, and extrapolation can be performed for each group; however, grouping of receivers may result in reduced image resolution in some implementations.

Of note, GmRTM does not require deriving Green's functions (calculating finite different solutions of wave equations) for each time interval. Instead, the same Green's function at each receiver can be used for different time intervals because the relationship between the Green's function and records is linear (equation (2)). The length of records (e.g., days to years) can be much longer than the length of the Green's function that is of interest to represent the wave propagation from a source to receivers (e.g., seconds to tens of seconds). Therefore, the wave equation can be solved for each receiver (estimate g(xᵣᵢ,x,ω) for each rᵢ) and can be convolved with the observed data (D(xᵣᵢ,ω)) in the image domain. For AmRTM, however, when equation (2) is solved for all receivers simultaneously, the equation is solved for each time interval because the summation over the receivers breaks the linearity. This indicates that GmRTM has a much lower computational cost for carrying out the finite-difference operation than does AmRTM for continuous data.

For example, consider that ground motion is continuously recorded for 50 days with 1000 receivers. If possible microseismic source locations are within a distance of 30 s from the receivers, the Green's function can be derived for just 30 s. The total numerical time of the wavefield extrapolation is 1000×30=30,000 s for GmRTM and 1×50×24×60×60=4,320,000 s for AmRTM. Therefore, the computational cost for GmRTM is more than 100 times less than for time-reversal imaging. Here, it can be assumed that events' waveforms are difficult to identify in the data domain (low S/N data). Moreover, finding source locations from 4D images given by AmRTM can be difficult because images may not have a clear, isolated maximum as is the case for GmRTM. Sharpening an image and reducing the search dimension provide an important advantage for GmRTM. In particular, searching for imaged events through time in AmRTM can be quite time consuming and can involve subjective interpretation.

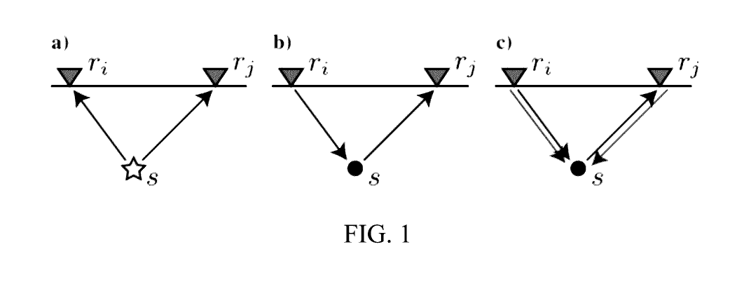

Equation (3) can be interpreted by considering one receiver as a virtual source within the concept of convolution-based seismic interferometry. FIG. 1a shows the wave propagation generated by a seismic source at x_{s.} The observed data related to this source is represented in equation (1). For purposes of explanation, it can be assumed that the source function is a delta function in the time domain, such that the convolution function between the observed data at receivers rᵢ and rⱼ is G(xᵣᵢ,xₛ)G(xᵣⱼ,xₛ) in the frequency domain. This convolution function can be interpreted as virtual-reflector signals after an appropriate integral over sources. Because seismic sources distributed discretely in space are of interest (e.g., no integral is derived), the sources can be considered as virtual scatterers, and the receiver rᵢ as a virtual source as shown in FIG. 1b (with reciprocity G(xᵣᵢ,xₛ)=G(xₛ,xᵣᵢ)). Applying an active-shot RTM to the convolution function, an image of the virtual scatterer (seismic source) can be derived as follows:

$$i ( x ) = {\sum }_{ω} {𝒢}^{*} ( x , {x}_{{r}_{i}} ) [ G ( {x}_{{r}_{i}} , {x}_{s} ) G ( {x}_{{r}_{j}} , {x}_{s} ) {𝒢}^{*} ( x , {x}_{{r}_{j}} ) ] , \qquad ( 7 )$$

where the first term on the right side represents the virtual-source wavefields and the bracketed term represents the receiver wavefields (FIG. 1c). The complex conjugate on the virtual-source wavefields is related to the imaging condition given by crosscorrelation. Equation (7) can correspond to equation (3) with reciprocity because

$$\begin{matrix}i ( x ) = {\sum }_{ω} [ G ( {x}_{{r}_{i}} , {x}_{s} ) {𝒢}^{*} ( {x}_{{r}_{i}} , x ) ] [ G ( {x}_{{r}_{j}} , {x}_{s} ) {𝒢}^{*} ( {x}_{{r}_{j}} , x ) ] \\ = {\sum }_{ω} {W}_{{r}_{i}} ( x ) {W}_{{r}_{j}} ( x ) \\ = {ℐ}_{ij} ( x ) .\end{matrix} \qquad ( 8 )$$

Equation (8) indicates that GmRTM can be extended by applying techniques in active-source RTM, such as angle-domain gathers, migration velocity analysis, and extended imaging condition. In addition, GmRTM can be applied for diffraction imaging as well.

Implementation of GmRTM

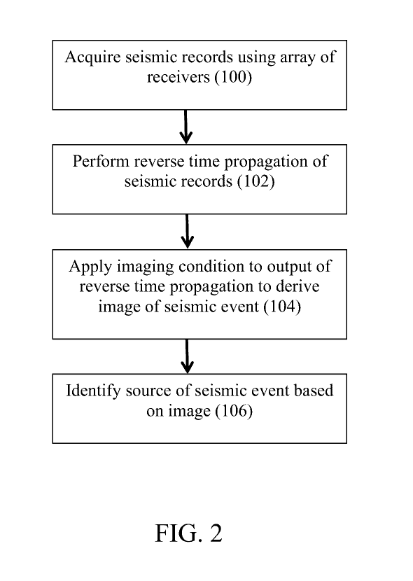

FIG. 2 is a flow chart of operations implemented according to GmRTM of some embodiments of this disclosure.

In stage 100, seismic records are acquired using an array of receivers. In some embodiments, a seismic record for each receiver of the array is acquired and received for further processing, and a seismic record acquired for each receiver is in the form of a recorded wavefield at a respective receiver location. A number of receivers in the array can be greater than 2, such as 3 or more, 4 or more, 5 or more, 10 or more, 50 or more, 100 or more, 500 or more, or 1000 or more, although 2 or less receivers are also encompassed by this disclosure. Receivers in the array can be any suitable sensors for measuring seismic waves, such as seismometers for measuring particle dynamics in the form of particle displacements or derivatives of displacements. Seismometers can include sensing technologies such as balanced force feed-back or an electrochemical sensor. Data measurements can be recorded as, for example, particle velocity values, particle acceleration values, or particle pressure values.

Next, in stage 102, reverse time propagation of the seismic records is performed. In some embodiments, a seismic record for each receiver of the array (in the form of a recorded wavefield at a respective receiver location) is subjected to reverse time propagation to derive an extrapolated wavefield for a respective receiver. In some embodiments, an extrapolated wavefield is multidimensional and includes components along two or more spatial dimensions and one temporal (time) dimension, for a total of three dimensions in the case of two spatial dimensions and one time dimension, or a total of four dimensions in the case of three spatial dimensions and one time dimension. Propagation of a recorded wavefield can be performed based on a velocity model of a propagating medium after reversing the time axis. In particular, propagation of a recorded wavefield can be performed by injecting the recorded wavefield as a source and propagating in reverse time based on an approximated Green's function, which can be derived based on the velocity model using a finite-difference or other numerical solution of the wave equation (see equation (2)). For example, a multidimensional finite-difference wave equation solver can be used for reverse time propagation. Other reverse time propagation techniques are encompassed by this disclosure, such as based on ray-tracing or pseudo-spectral wave field extrapolators. Output from reverse time propagation can be in the form of, for example, particle velocity values, particle acceleration values, or particle pressure values along two or more spatial dimensions and one time dimension.

Next, in stage 104, an imaging condition is applied to the output of reverse time propagation to derive an image of a seismic event. The imaging condition is based on multidimensional crosscorrelation (geometric mean) of extrapolated wavefields for receivers of the array. In particular, the image of the seismic event is derived as a product of extrapolated wavefields for receivers of the array and with summation over the time axis (see equation (6)), thereby collapsing the time axis to reduce scanning dimensions of the image by one (no time). Summation over time can be performed over an entire time interval of seismic records, or over a user-selected time interval to encompass, for example, an onset time of the seismic event that is known or of interest. In addition to reducing scanning dimensions from four to three in the case of three spatial dimensions (or from three to two in the case of two spatial dimensions), the summation over time of the product of extrapolated receiver wavefields can increase a spatial resolution of the resulting image.

Next, in stage 106, a source of the seismic event is identified based on the image. In some embodiments, a location of the seismic source is derived by identifying an extremum (e.g., a maximum or a peak) in the image, such as by scanning along one or more directions in the image. The location of the seismic source can be displayed along with displaying the image, such as by generating display data superimposing an indication of the seismic source onto its corresponding location in the image. In addition to, or in place of, localizing a seismic source, other aspects of a seismic event can be characterized based on an image of the seismic event. For example, a seismic event can be detected by identifying an extremum in the image having a magnitude that exceeds a threshold value. As another example, the seismic event can be categorized or otherwise characterized based on the magnitude of the extremum or a spatial distribution of image values around the extremum.

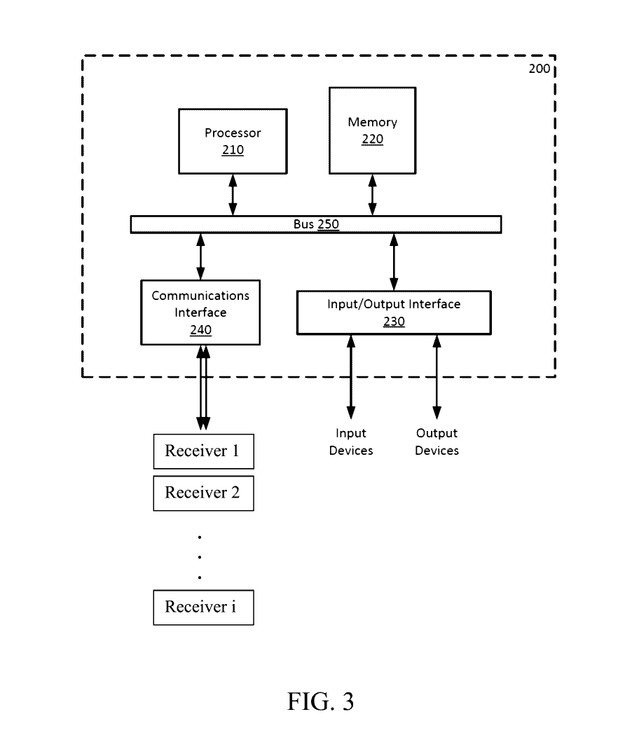

FIG. 3 is a schematic of a system in which operations of GmRTM can be implemented according to some embodiments of this disclosure.

As shown, the system includes a computing device 200 that includes a processor 210, a memory 220, an input/output interface 230, and a communications interface 240. A bus 250 provides a communication path between two or more of the components of the computing device 200. The components shown are provided by way of example. The computing device 200 can have additional or fewer components, or multiple of the same component.

The processor 210 represents one or more of a microprocessor, a microcontroller, an application-specific integrated circuit (ASIC), and a field-programmable gate array (FPGA), along with associated logic.

The memory 220 represents one or both of volatile and non-volatile memory for storing information. Examples of the memory 220 include semiconductor memory devices such as erasable programmable read-only memory (EPROM), electrically erasable programmable read-only memory (EEPROM), random-access memory (RAM), and flash memory devices, discs such as internal hard drives, removable hard drives, magneto-optical, compact disc (CD), digital versatile disc (DVD), and Blu-ray discs, memory sticks, and the like. Certain operations of GmRTM of some embodiments can be implemented as computer-readable instructions in the memory 220 of the computing device 200, executed by the processor 210.

The input/output interface 230 represents electrical components and optional instructions that together provide an interface from the internal components of the computing device 200 to external components, such as a display device. Examples include a driver integrated circuit with associated programming.

The communications interface 240 represents electrical components and optional instructions that together provide an interface from the internal components of the computing device 200 to external devices, optionally through a computer network. As shown, the computing device 200 is connected to an array of receivers, including receiver 1, receiver 2, and up through receiver i. A number of receivers in the array (namely i) can be greater than 2, such as 3 or more, 4 or more, 5 or more, 10 or more, 50 or more, 100 or more, 500 or more, or 1000 or more, although 2 or less receivers are also encompassed by this disclosure.

Some embodiments of this disclosure relate to a non-transitory computer-readable storage medium having computer code or instructions thereon for performing various computer-implemented operations. The term “computer-readable storage medium” is used to include any medium that is capable of storing or encoding a sequence of instructions or computer code for performing the operations, methodologies, and techniques described herein. Examples of computer-readable storage media include those specified above in connection with the memory 220, among others.

Examples of computer code include machine code, such as produced by a compiler, and files containing higher-level code that are executed by a processor using an interpreter or a compiler. For example, an embodiment of the disclosure may be implemented using Java, C++, or other programming language and development tools. Additional examples of computer code include encrypted code and compressed code. Moreover, an embodiment of the disclosure may be downloaded as a computer program product, which may be transferred from a remote computer (e.g., a server computer) to a requesting computer (e.g., a client computer or a different server computer) via a transmission channel. Another embodiment of the disclosure may be implemented in hardwired circuitry in place of, or in combination with, processor-executable software instructions.

### EXAMPLE

The following example describes specific aspects of some embodiments of this disclosure to illustrate and provide a description for those of ordinary skill in the art. The example should not be construed as limiting this disclosure, as the example merely provides specific methodology useful in understanding and practicing some embodiments of this disclosure.

### Reverse Time Migration for Microseismic Sources Using a Geometric Mean as an Imaging Condition

In this example, two-dimensional (2D) acoustic numerical experiment is used to show the effectiveness of geometric-mean reverse time migration (GmRTM). With the same 2D experiment, GmRTM is subjected to tests under different conditions including velocity model errors, noise, and multiple sources. It is found that GmRTM works well, and it improves the spatial resolution of an image and reduces the strength of artifacts.

Numerical Tests

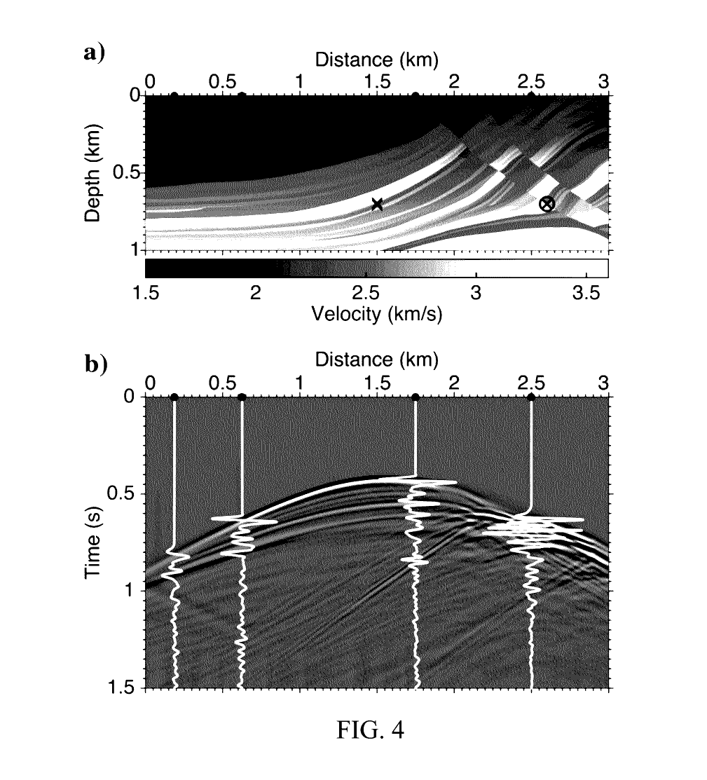

2D acoustic finite-difference numerical modeling is used to illustrate the benefits of GmRTM. Although a 2D acoustic medium is used in this example, GmRTM can be applied to three-dimensional (3D) media and elastic cases as well. For 3D, the concept of RTM is similar as that for 2D, but the computational cost is increased. For the elastic case, a technique such as, for example, Helmholz decomposition can be used to scalarize the wavefields before reverse time migration (RTM). A part of the Marmousi model is used to introduce some complexity into the numerical experiments (FIG. 4a). The part of the model used is 4.5-7.5 km in the horizontal axis and 0.55-1.55 km in the vertical axis of the P velocities of the Marmousi model. The free surface in the model is not included in this example. A seismic source is introduced, which is shown with a cross in FIG. 4a located just below the high-velocity layer ((x,z)=(1.5, 0.7) km), along with four receivers that record seismic waves at the surface (the dots in FIG. 4a). The source function is a Ricker wavelet (peak frequency of 30 Hz). For the wavefield modeling, the time and space sampling intervals are 0.15 ms and 1.249 m, respectively. Here, the correct velocity model is used for migration, and the discussion of the influence of velocity model errors is deferred.

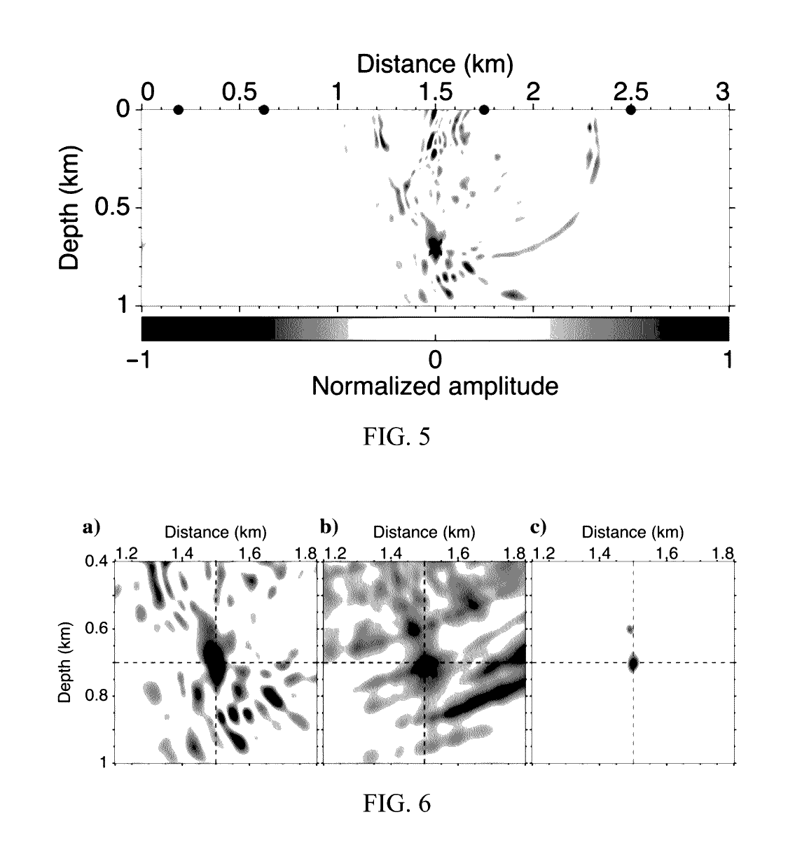

The time-reversal imaging (arithmetic-mean RTM (AmRTM), equation (2)) at time t₀ of the maximum amplitude of I(x,t) provides the image of the source location (FIG. 5). Because the correct velocity model is used for migration and the Ricker wavelet is used as a source function, the time t₀ shows the origin time of the source. Although strong artifacts are present due to the relatively small number of receivers, the waves are correctly focused at the true location of the source (FIG. 6a). The autocorrelation RTM (equation (5)) provides an image without the time axis, but the image is highly smeared due to the small number of receivers and the complex velocity model (FIG. 6b). The amplitudes of the image are all positive due to the autocorrelation. The GmRTM (equation (6)) creates the clearest source image and suffers fewer artifacts (FIG. 6c). Note that GmRTM also collapses the time axis, and thus scanning can be performed just along the space axes to find the source location.

For autocorrelation RTM and GmRTM, averaging is performed over the entire time interval to create the images in FIG. 6. An arbitrary time interval can be selected for averaging if the onset time of seismic sources is known (e.g., a perforation shot) or if the time sequence of sources is of interest. Therefore, GmRTM can handle multiple sources emitted at different times and can have the same or similar temporal resolution as AmRTM, but averaging over the entire time interval reduces the cost of the searching process, which is nontrivial.

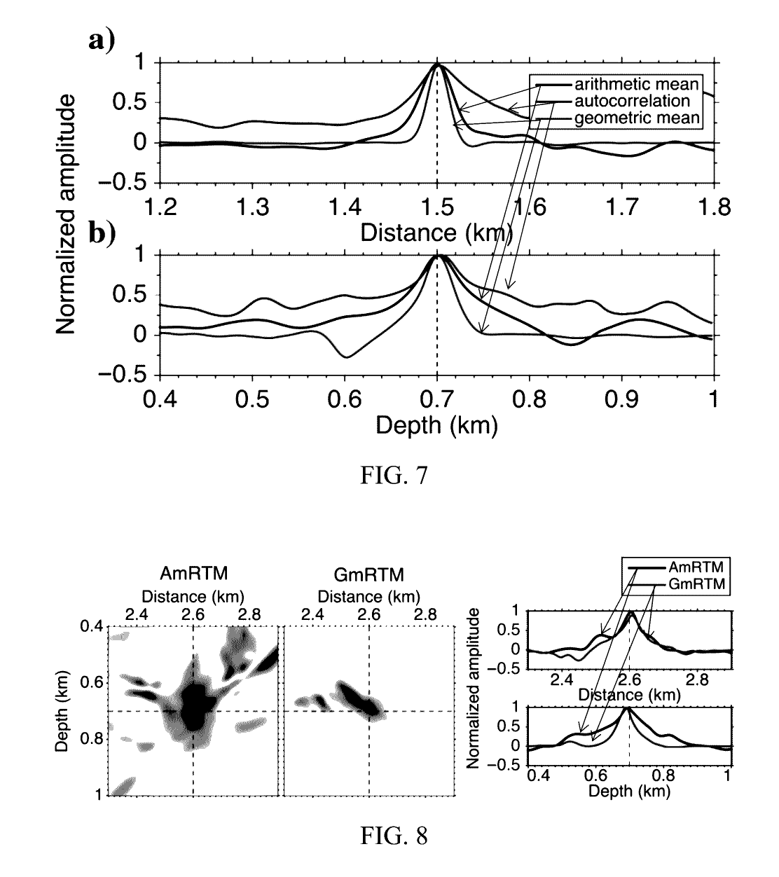

FIG. 7 shows the vertical and horizontal traces of each image. The GmRTM results in the sharpest image, especially in the depth direction, which is attributable to the multiplication of Ricker wavelets resulting in a sharper wavelet in the time domain. The ability of GmRTM to create images with high spatial resolution and to separate two nearby sources due to this multiplication is discussed in the next section. Importantly, GmRTM shows almost zero amplitude away from the source location (few artifacts), and hence it is less likely to misinterpret imaging artifacts as seismic sources using GmRTM. In RTMs based on surface recordings, an image can smear more vertically because the receivers are distributed horizontally resulting in increased cross-range resolution.

An additional test of GmRTM is performed by placing a source at a geologically more challenging location for imaging (the [symbol] in FIG. 4). All receivers are on the left side of the source, and the geology in the vicinity is complex. Although both images are degraded compared with the image of the source that is recorded by the wide-aperture array (FIG. 6), GmRTM constructs the image with fewer artifacts than does AmRTM (FIG. 8). The GmRTM image smears into the top-left side of the source location. This image portion is caused by strong waves that are guided by the low-velocity zone. The AmRTM images are not smeared by these guided waves because the image in FIG. 8 is a time slice. It is likely that this would have been interpreted as another source if searching for sources at different times via AmRTM processing.

Discussion

The following addresses the effects of velocity model errors, finite-time source wavelets, and random/coherent noise on GmRTM and the improvement in spatial resolution that results from the multiplication of multiple waveforms and how it improves the ability to discern clear images of multiple sources. All of these factors are important to consider for applications with real data. In the following, the same parameters are used as the previous numerical test, unless noted.

Velocity Model Error

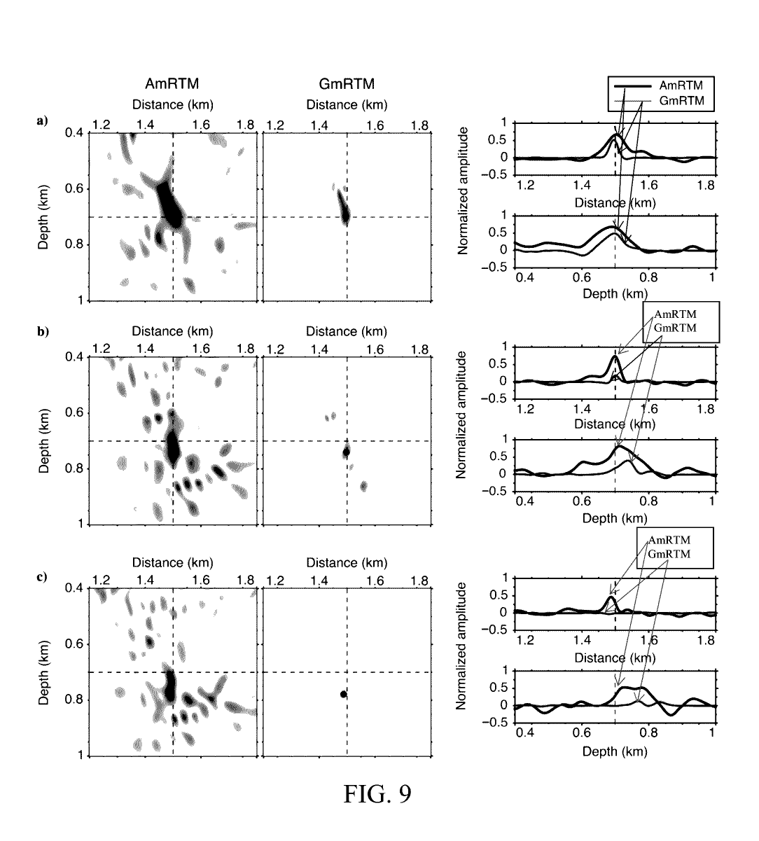

First, a smoothed velocity model (smoothed with a 100×100 m² 2D triangular filter, not shown) is used for migration, which is more realistic than using the correct velocity model due to constraints in velocity estimation. Because the mean velocity along the ray paths is nearly correct, the wavefields are still focused around the correct source location with either AmRTM or GmRTM (FIG. 9a), but the images are smeared compared with FIG. 6. The maximum amplitudes of the images decrease approximately 50%. GmRTM works better in this case based on the better localization of maximum amplitude and lesser degree of smearing.

Another realistic case is when mean velocities differ from the correct velocities. To test the effect of such errors, 5% and 10% velocity errors are introduced for migration velocities (FIGS. 9b and 9c). Because the migration velocities are slower than the true velocities, the image of the seismic sources shift deeper, and the errors degrade the images for both RTM results. Based on the amplitudes of the images, GmRTM is sensitive to the velocity model, and an amplitude as low as 20% is obtained from the imperfect focusing of wavefields in FIG. 9c compared with the image in FIG. 6c. AmRTM is less sensitive to the velocity model; however, that also means it has a larger chance of focusing at an incorrect location. As with the active-shot RTM, because there are time and space lags in the image (equation (3)), the seismic sources can still be detected with GmRTM, and the velocity model can be updated with GmRTM even when starting migration velocities are not accurate. Inversion techniques can be used for migration velocity analysis.

Length of Source Wavelet and Noise

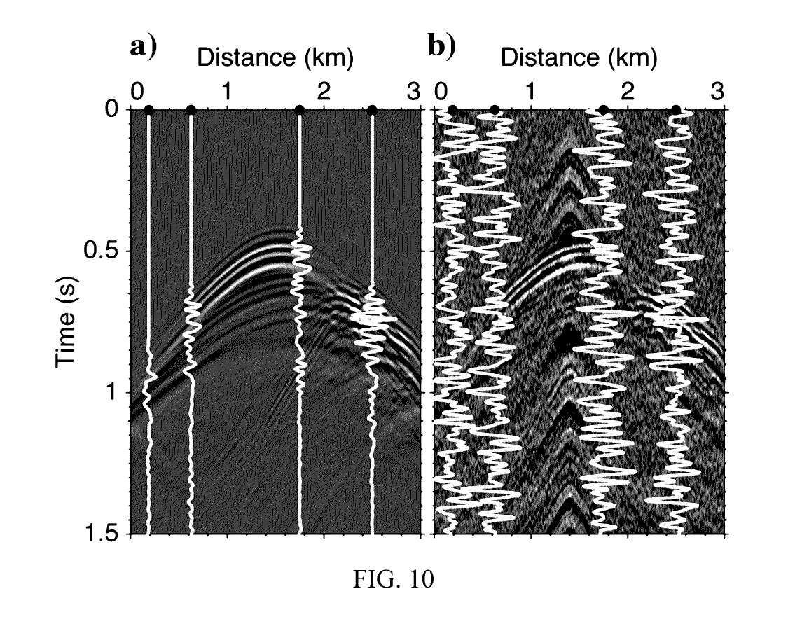

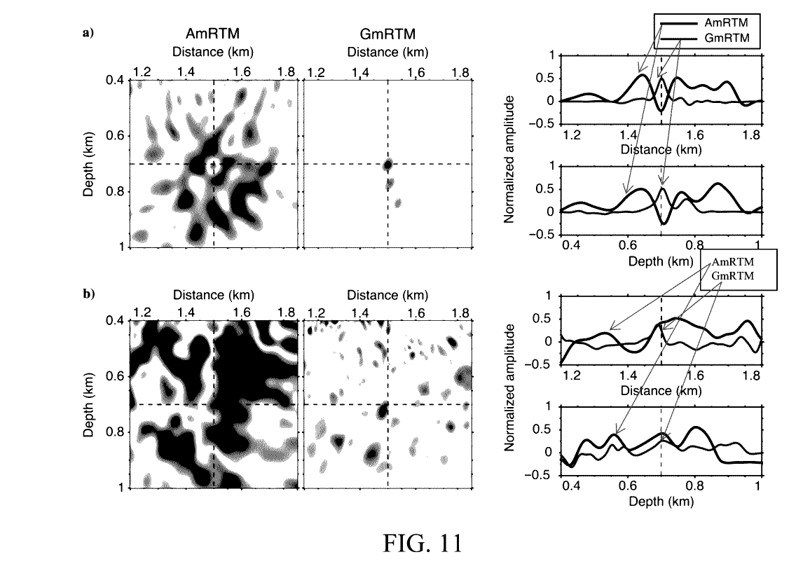

Averaging over time in GmRTM (equation (6)) reduces the computational effort involved for source imaging; moreover, it will also increase the signal-to-noise ratio (S/N) of the image when seismic events have finite length source durations. The rupture process of some seismic events takes seconds to a few minutes. FIG. 10a shows synthetic records computed with a 0.225 s wavelet. The wavelet contains energies between 5 and 40 Hz. After migrating these records, GmRTM produces a sharp image of the seismic source (FIG. 11a). The sharpness of the image at the source location is not very different from FIG. 6c. At approximately 50 m and 100 m below the correct source location, GmRTM creates two more bright spots, although the amplitudes are reduced by approximately 50% from the maximum amplitude in the image. These images may be the result of the interference of direct and reflected waves because RTMs used in this example are based on the Born approximation. Because t₀ is selected when the image has the largest amplitude, AmRTM does not focus at the correct source location and has multiple broad, large-amplitude spots (FIG. 11a). Because the image of AmRTM is a time slice, AmRTM cannot use the majority of energy generated by the source for imaging when the source wavelet/duration is extended in time.

When two types of noise (random and coherent) are added to the synthetic records (FIG. 10b), the images are further degraded (FIG. 11b). The random noise is a band-limited white noise (5-40 Hz), and the amplitude of the random noise is 50% of the maximum amplitude of noise-free data shown in FIG. 10a. For the coherent noise, additional band-limited white noise (5-40 Hz with 10% amplitude) is injected at (x,z)=(1.5; 0.02) km. This coherent noise might represent persistent sources of interference such as can arise from pumping or traffic. After adding the noise, finding the seismic signature of the event in the data (the white lines in FIG. 10a) is essentially impossible; however, FIG. 11b shows that GmRTM still provides an amplitude peak around the source location (more than twice the amplitude of other maxima in the image). Here again, the crosscorrelation and time averaging (equation (6)) help to suppress the noise in the image. However, AmRTM does not focus the wavefields.

The viability of travel time picking to detect seismic sources depends on discerning discrete arrivals at each receiver. When seismic events are strong and data have high S/N, the arrival times of waves can be accurately estimated; however, finding the arrival times for small earthquakes is more challenging. To increase the detectability of smaller events, more information in either, or both, the time and space domains should be used. For example, template-matching and autocorrelation techniques use finite time samples. Time-reversal techniques take advantage of using multiple receivers simultaneously. Depending on imaging conditions, migration-based approaches also can use multiply scattered waves for detection. GmRTM can use finite time samples and multiple receivers to find seismic events (equation (6)); therefore, GmRTM can have higher detectability than the techniques using just space or time samples. In other words, GmRTM effectively uses signals scattered in time and space (FIG. 10) to construct a source image. Increasing the detectability is desirable because smaller events may be linked to larger events.

Spatial Resolution

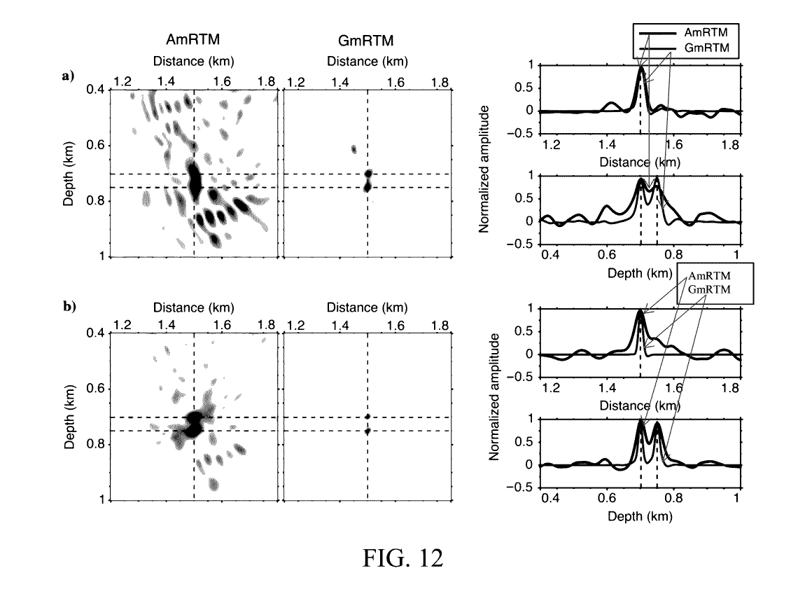

The ability of GmRTM to image multiple sources is tested. During hydraulic fracturing, earthquake swarms, or tremor, many sources can occur in close temporal and spatial proximity. For this test, an additional source is placed 48 m below the one used previously (FIG. 12a). These sources act at the same time with the same amplitude and frequency range. Because the velocity at the source locations is approximately 2.5 km/s, the source separation of 48 m is about a half wavelength. Also, because the image tends to smear vertically, two sources that are vertically aligned will be challenging to image. The image created by GmRTM clearly separates two sources better than AmRTM does (FIG. 12a). In addition, as observed in other tests, GmRTM has fewer artifacts in the image. These trends are more noticeable when eight receivers are used (FIG. 12b). An additional four receivers are placed at the center of each receiver pair in FIG. 4 (two receivers are added between the second and third receivers). This improves both images. The wavefields are slightly improved in AmRTM, but the GmRTM image is exceptionally clear, with just two bright spots at the correct source locations. The width of the images is much smaller than the wavelength, which indicates that GmRTM has the potential to image with super-resolution. Deconvolution can be used instead of crosscorrelation for the imaging condition in equation (6) to increase the spatial and temporal resolution.

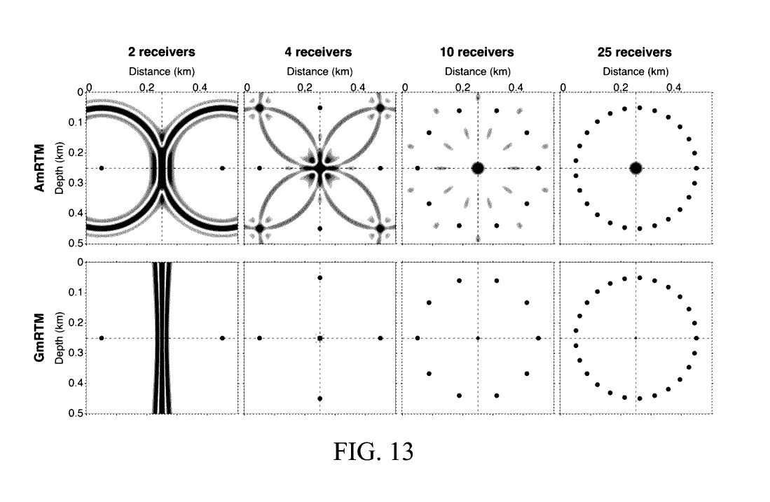

A homogeneous-model test shows that GmRTM surpasses the diffraction limit of time-reversal imaging (FIG. 13). Because a band-limited impulsive source is used for this numerical test, one can consider that the images are the array response. When the number of receivers used is increased, better S/N images for AmRTM and GmRTM are obtained. For AmRTM, diffraction limits blur the source images, and the size of imaged sources does not noticeably change from 10 to 25 receivers. When the number of receivers increases, the image of GmRTM better focuses on the source location even from 10 to 25 receivers. Of note, the focusing size of GmRTM is much smaller than AmRTM.

Conclusions

GmRTM is developed and tested for estimation of passive seismic source location. GmRTM is a correlation-based imaging technique, and, to find the source location, scanning can be performed just along the space axes, not the time axis. The computational cost of GmRTM for continuous records is much smaller than for other back-projection techniques. Compared with time-reversal imaging (AmRTM) or autocorrelation RTM, GmRTM creates spatially higher resolution source images. Although GmRTM is sensitive to the velocity model (for example, at least as sensitive as AmRTM), time/space lags of crosscorrelation can be used to update the velocity model. GmRTM is robust with respect to random and coherent noise because the crosscorrelation effectively suppresses noise in both cases. It is better suited to imaging sources extended in time than AmRTM due to the collapse of the time axis. The increase in the spatial resolution of images in GmRTM provides a greater ability to separate multiple sources excited close to each other in space and time. GmRTM is scale independent, and thus the technique can be applied from the microseismic to crustal scales. Application of GmRTM also can be extended to 3D data sets.

By way of summary for some embodiments, this disclosure sets forth an improved technique of time-reversal imaging termed GmRTM, which can detect, locate, and characterize seismic events from seismic records. Among the benefits is the use of geometric mean or crosscorrelation as an imaging condition. GmRTM is robust for seismic records with lower S/N, is computationally less demanding than other approaches, and provides spatially higher resolution source images. GmRTM provides improvement in detectability of seismic events and spatial resolution of source images while reducing a volume of scanning. The technique can be applied at various scales, including oil/gas/geothermal reservoirs, volcanoes, and crustal earthquakes.

Features of some embodiments of GmRTM include: (1) a product-based reverse time imaging condition for passive seismic events; and (2) use of geometric mean with more than three extrapolated wavefields for imaging condition.

Additional features and benefits of some embodiments of GmRTM include: (1) improvement in spatial resolution of reverse time seismic source images and detectability of seismic events from continuous seismic records; (2) reduction in computational effort to scan continuous seismic records; (3) ability to detect small-scale (weak) events (low S/N) because GmRTM can simultaneously use all recorded wavefields to focus generated energy from a source at a hypocenter; (4) reduction in scanning dimension from four dimensions to three dimensions (space with no time) with an accompanying decrease in computational effort; (5) higher spatial resolution of source images due to multiplication or product, rather than addition, of multiple migrated wavefields; (6) concurrent implementation of detection, localization, and characterization of seismic events; (7) extendable to allow updating velocity models with correlation lags of crosscorrelation in frequency domain; and (8) relaxation or omission of criteria of a regular array of receivers.

GmRTM of some embodiments can be adapted to multiple wave types such as P and S waves with anisotropy, and extended to multiple waves.

GmRTM is scale-independent, and can be applied to seismic records from oil/gas/geothermal reservoirs to crustal scales. Applications include, for example: (1) oil/gas reservoirs: detecting, localizing and characterizing microseismic events that occur during hydro-fracturing and production; (2) enhanced geothermal energy production: monitoring induced seismicity related to water injection; and (3) natural earthquakes and volcanoes: monitoring activities of small earthquakes and volcanic events.

As used herein, the singular terms “a,” “an,” and “the” include plural referents unless the context clearly dictates otherwise. Thus, for example, reference to an object can include multiple objects unless the context clearly dictates otherwise.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

While the disclosure has been described with reference to the specific embodiments thereof, it should be understood by those skilled in the art that various changes may be made and equivalents may be substituted without departing from the true spirit and scope of the disclosure as defined by the appended claims. In addition, many modifications may be made to adapt a particular situation, material, composition of matter, method, operation or operations, to the objective, spirit and scope of the disclosure. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations is not a limitation of the disclosure.

What is claimed is:

1. A non-transitory computer-readable storage medium storing processor-executable instructions to:
for each receiver of an array of three or more receivers monitoring a seismic event, perform reverse time propagation of a recorded wavefield for the respective receiver to derive an extrapolated wavefield for the respective receiver;
apply an imaging condition as a crosscorrelation of the extrapolated wavefields for the three or more receivers to derive an image of the seismic event; and
identify a source of the seismic event based on the image.

2. The non-transitory computer-readable storage medium of claim 1, wherein the processor-executable instructions to apply the imaging condition include processor-executable instructions to apply the imaging condition as a zero time lag crosscorrelation of the extrapolated wavefields for the three or more receivers.

3. The non-transitory computer-readable storage medium of claim 1, wherein the processor-executable instructions to apply the imaging condition include processor-executable instructions to perform a summation over time of a product of the extrapolated wavefields for the three or more receivers.

4. The non-transitory computer-readable storage medium of claim 3, further storing processor-executable instructions to receive a user-selected time interval, and wherein the processor-executable instructions to perform the summation include processor-executable instructions to perform the summation over the user-selected time interval.

5. The non-transitory computer-readable storage medium of claim 1, wherein the processor-executable instructions to identify the source of the seismic event include processor-executable instructions to derive a location of the source of the seismic event by identifying an extremum in the image.

6. The non-transitory computer-readable storage medium of claim 5, wherein the processor-executable instructions to derive the location of the source of the seismic event include processor-executable instructions to scan along one or more spatial dimensions in the image to identify the extremum, in the absence of scanning along a time dimension.

7. The non-transitory computer-readable storage medium of claim 1, further comprising processor-executable instructions to superimpose an indication of the source of the seismic event onto the image.

8. A system comprising:
a processor; and
a memory connected to the processor, the memory storing instructions executable by the processor to:
for each receiver of an array of three or more receivers monitoring a seismic event, perform reverse time propagation of a seismic record for the respective receiver to derive an extrapolated wavefield for the respective receiver;
derive an image of the seismic event by performing a summation over time of a product of the extrapolated wavefields for the three or more receivers; and
derive a location of a source of the seismic event based on the image.

9. The system of claim 8, wherein the instructions to derive the image include instructions to perform the summation over a user-selected time interval.

10. The system of claim 8, further comprising the array of the three or more receivers, the array being connected to the processor.

11. A method comprising:
for each receiver of an array of three or more receivers, acquiring a seismic record for the respective receiver;
for each receiver of the array, performing reverse time propagation of the seismic record for the respective receiver to derive an extrapolated wavefield for the respective receiver;
applying an imaging condition as a crosscorrelation of the extrapolated wavefields for the three or more receivers of the array to derive an image of a seismic event; and
identifying a source of the seismic event based on the image.

12. The method of claim 11, wherein applying the imaging condition includes applying the imaging condition as a zero time lag crosscorrelation of the extrapolated wavefields for the three or more receivers of the array.

13. The method of claim 11, wherein applying the imaging condition includes performing a summation over time of a product of the extrapolated wavefields for the three or more receivers of the array.

14. The method of claim 11, wherein identifying the source of the seismic event includes deriving a location of the source of the seismic event by identifying an extremum in the image.
